(19) United States
(12) Patent Application Publication
(10) Pub. No.: US 2016/0188067 A1
(43) Pub. Date: Jun. 30, 2016

(54) ELECTRONIC DEVICE AND METHOD FOR CONTROLLING DISPLAYED INTERFACE ACCORDING TO MANNER IN WHICH DEVICE IS HANDHELD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: Sheng HOU, Shenzhen (CN); Chih-San CHIANG, New Taipei (TW); Hai-Sheng LI, Shenzhen (CN); Zhao-Ping ZHANG, Shenzhen (CN); Hui-Gang HE, Shenzhen (CN)

(21) Appl. No.: 14/797,664

(22) Filed: Jul. 13, 2015

(30) Foreign Application Priority Data
Dec. 27, 2014 (CN) 201410825158.2

(51) Int. Cl. G06F 3/041

(52) U.S. Cl. CPC G06F 3/0414

(57) ABSTRACT

An electronic device and display method includes sensing plates mounted on the electronic device and configured to generate signals when the electronic device is handheld. Programs cause at least one processor to analyzes the signals and thus the manner in which the electronic device is handheld. The method displays an interface according to the manner in which the device is handheld.

### CROSS-REFERENCE TO RELATED APPLICATIONS

This application claims priority to Chinese Patent Application No. 201410825158.2 filed on Dec. 27, 2014, the contents of which are incorporated by reference herein.

### FIELD

The subject matter herein generally relates to display control.

### BACKGROUND

Electronic devices can usually display various of interfaces, including some virtual buttons. A user can tap a virtual button to operate an electronic device.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an electronic device applying a display control system.

FIG. 2 is an elevational view of a first interface displayed on the electronic device of FIG. 1.

FIG. 3 is an elevational view of a sensing plate mounted on back of the electronic device of FIG. 2.

FIG. 4 is an elevational view of the sensing plate mounted on two side walls of the electronic device of FIG. 2.

FIG. 5 is an elevational view of a second interface displayed on the electronic device of FIG. 2 when the electronic device is held by a user.

FIG. 6 is an elevational view of a third interface displayed on the electronic device of FIG. 2 when the electronic device is held by a user.

FIG. 7 is a flowchart of a first embodiment of a display control method for an electronic device, such as the one of FIG. 1.

FIG. 8 is a flowchart of a second embodiment of a display control method for an electronic device, such as the one of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

The present disclosure is described in relation to an electronic device and display method. The electronic device includes a sensing plate mounted on the electronic device and configured to generate a number of electric signals when the electronic device is held. Programs cause at least one processor to analyze the number of electric signals and determine a manner in which the electronic device is being held in the hand according to the signals. The method displays an interface including a sidebar corresponding to the handheld manner.

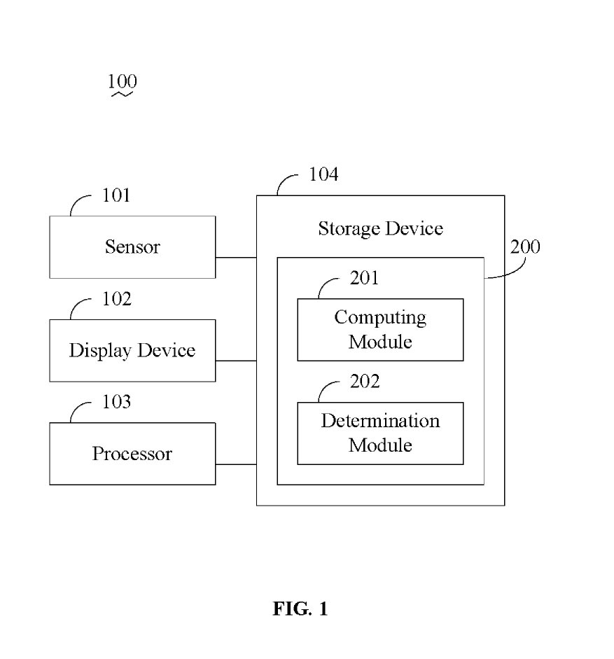

FIG. 1 illustrates an embodiment of an electronic device 100. A display control system 200 is applied to the electronic device 100. The electronic device 100 can be a mobile phone or a tablet computer, or other portable device. The electronic device 100 can include at least one sensing plate 101 and a display device 102. The electronic device 100 can also include at least one processor 103 and a storage device 104. In at least one embodiment, the electronic device 10 includes one processor 103. The processor 103 executes instructions of a number of modules stored in the storage device 104. The storage device 104 can store a computing module 201 and a determination module 202.

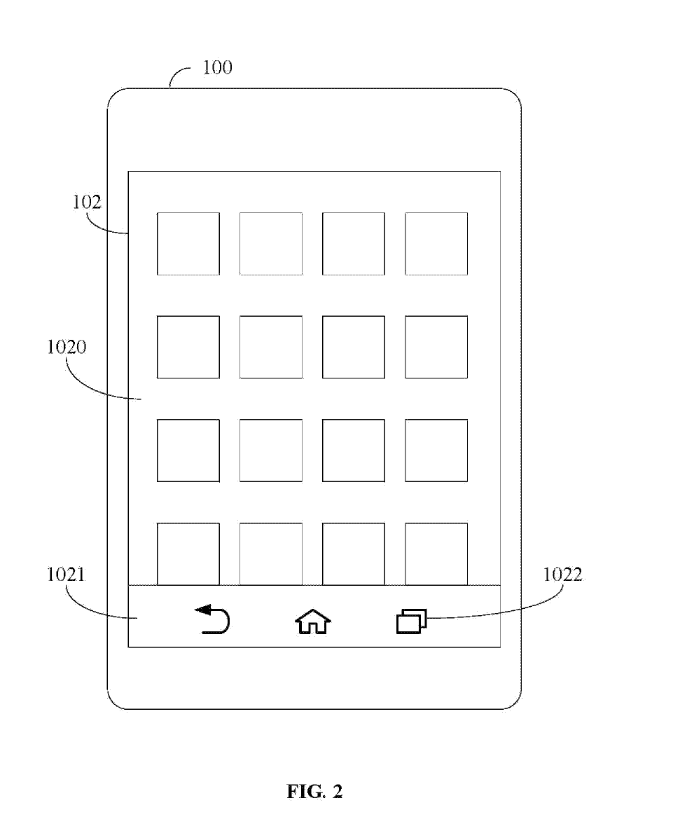

Referring to FIG. 2, the display device 102 can display a first interface 1020. The first interface 1020 includes a first sidebar 1021 in which a number of virtual buttons 1022 are displayed. In at least one embodiment, the first sidebar 1021 is displayed on the bottom of the first interface 1020. A user can tap one or more of the virtual buttons 1022 to operate the electronic device 100.

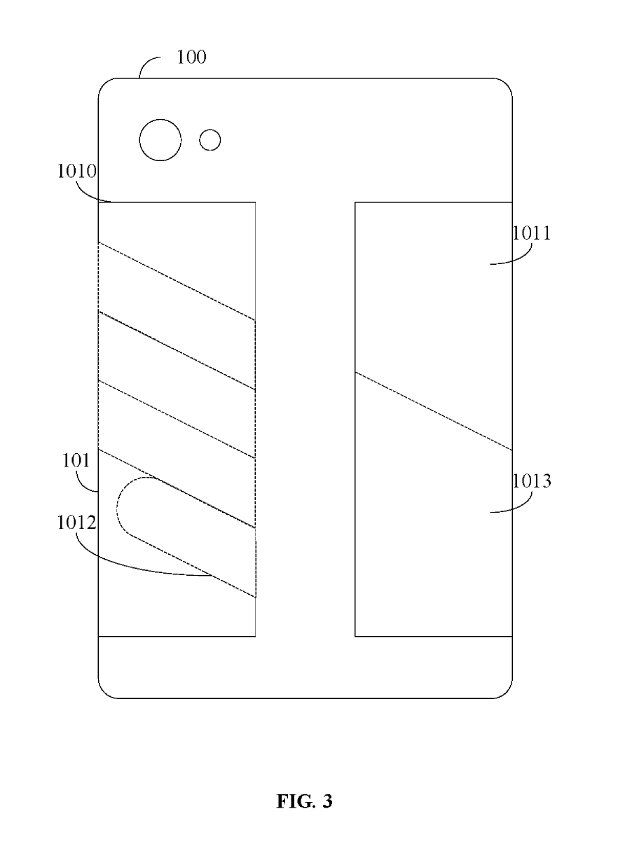

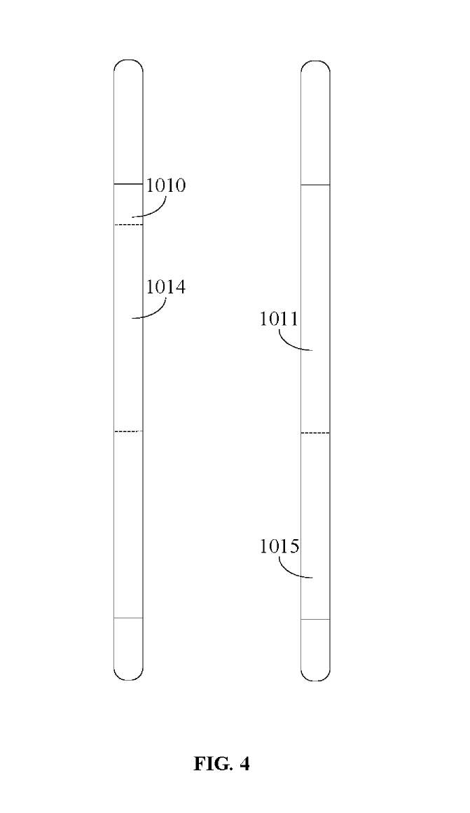

Referring to FIGS. 3-4, the at least one sensing plate 101 is mounted on the electronic device 100 to detect a manner in which the electronic device is being held in the hand(s) (hereinafter “holding status”) of the user. In at least one embodiment, the holding status can be holding with two hands, with a left hand, or with a right hand. The sensing plate 101 can be a pressure sensitive sensing plate or a touch sensitive sensing plate which includes a first sensing plate 1010 and a second sensing plate 1011. The first sensing plate 1010 is mounted on left of the back and left side of the electronic device 100, and the second sensing plate 1011 is mounted on right of the back and right side of the electronic device 100. When the electronic device 100 is handheld, a first region 1012 and a second region 1014 of the first sensing plate 1010 are touched and the first sensing plate 1010 generates a number of first electric signals. At the same time, a third region 1013 and a fourth region 1015 of the second sensing plate 1011 are touched and the second sensing plate 1011 generates a number of second electric signals. The computing module 201 can compute and analyze signals caused by the touches (hereinafter “holding data”) based on the number of first electric signals and the number of second electric signals. In at least one embodiment, the holding data can include values of a number of first pressures applied on the first region 1012 and the second region 1014, and values of a number of second pressures applied on the third region 1013 and the fourth region 1014. In an alternative embodiment, the holding data can also include a first area of the first region 1012 and the second region 1014, and a second area of the third region 1013 and the fourth region 1015.

In a first embodiment, the computing module 201 computes an average value of the first pressures based on the number of first electric signals. The computing module 201 further computes an average value of the second pressures based on the number of second electric signals. Specifically, the first sensing plate 1010 and second sensing plate 1011 both include a number of sensors. When the first region 1012 and second region 1014 are touched, the number of sensors on the first region 1012 and second region 1014 generate first electric signals having corresponding pressure information. When the third region 1013 and fourth region 1015 are touched, the number of sensors on the third region 1013 and fourth region 1015 generate second electric signals having corresponding pressure information. The computing module 201 computes the values of the number of first pressures based on the pressure information included in the first electric signals. The computing module 201 further computes the values of the number of second pressures based on pressure information included in the second electric signals. Then the computing module 201 computes the values of the respective averages of the first and second pressures.

The determination module 202 determines a holding status according to the values of the average first pressure and the average second pressure. In at least one embodiment, the determination module 202 calculates a difference between the two respective average values, then the determination module 202 determines whether the difference is smaller than a first preset value set by the user. If the difference is smaller than the first preset value, the determination module 202 determines that the electronic device 100 is held by two hands. If the difference is not smaller than the first preset value, the determination then determines whether the average value of the first pressures is smaller than the average value of the second pressures. If the average value of the first pressures is smaller than the average value of the second pressures, the determination module 202 determines that the electronic device 100 is held by a left hand. If the average value of the first pressures is not smaller than the average value of the second pressures, the determination module 202 determines that the electronic device 100 is held by a right hand.

In a second embodiment, the computing module 201 computes a size of a first area of the first region 1012 and the second region 1014 based on the number of first electric signals. The computing module 201 further computes a size of a second area of the third region 1013 and the fourth region 1015 based on the number of second electric signals. Specifically, the first sensing plate 1010 and second sensing plate 1011 both include a number of sensors. When the first region 1012 and second region 1014 are touched, the number of sensors on the first region 1012 and second region 1014 generate the number of first electric signals. When the third region 1013 and fourth region 1014 are touched, the number of sensors on the third region 1013 and fourth region 1014 generate the number of second electric signals. The computing module 201 can compute the size of the first area based on the amount of the number of first electric signals, and compute the size of the second area based on the amount of the number of second electric signals.

The determination module 202 determines a holding status according to the size of the first area and the size of the second area. In at least one embodiment, the determination module 202 determines a difference between the two respective sizes of the first area and the second area, then the determination module 202 determines whether the difference is smaller than a second preset value set by the user. If the difference is smaller than the second preset value, the determination module 202 determines that the electronic device 100 is held by two hands. If the difference is not smaller than the second preset value, the determination module 202 determines whether the first area is smaller than the second area. If the size of the first area is smaller than the size of the second area, the determination module 202 determines that the electronic device 100 is held by the left hand. If the size of the first area is not smaller than the size of the second area, the determination module 202 determines that the electronic device 100 is held by the right hand.

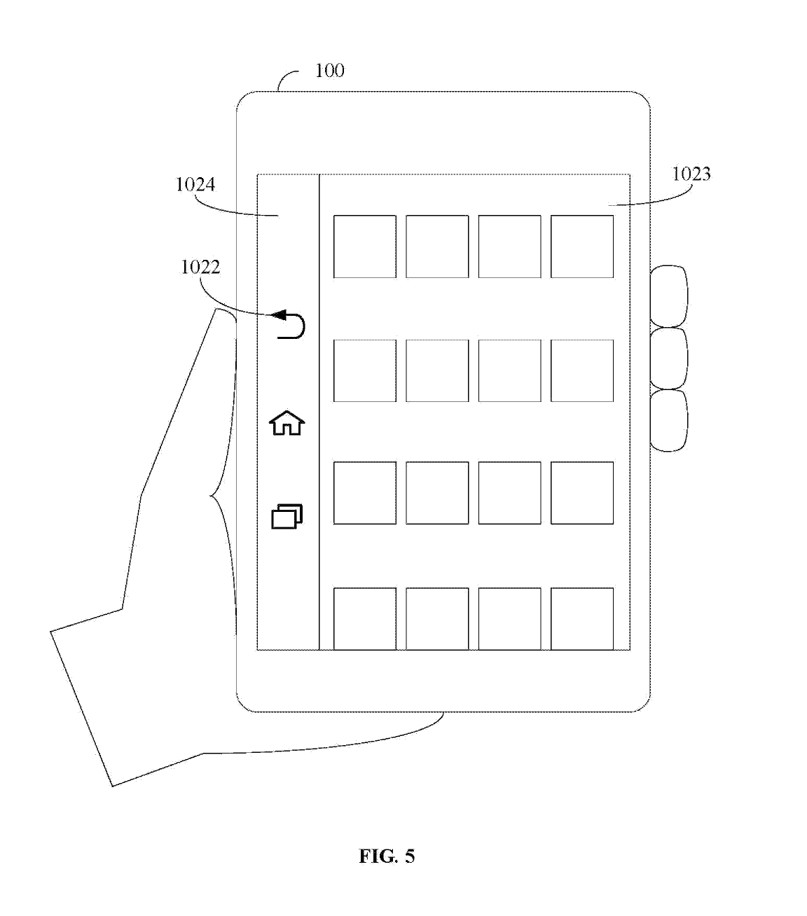

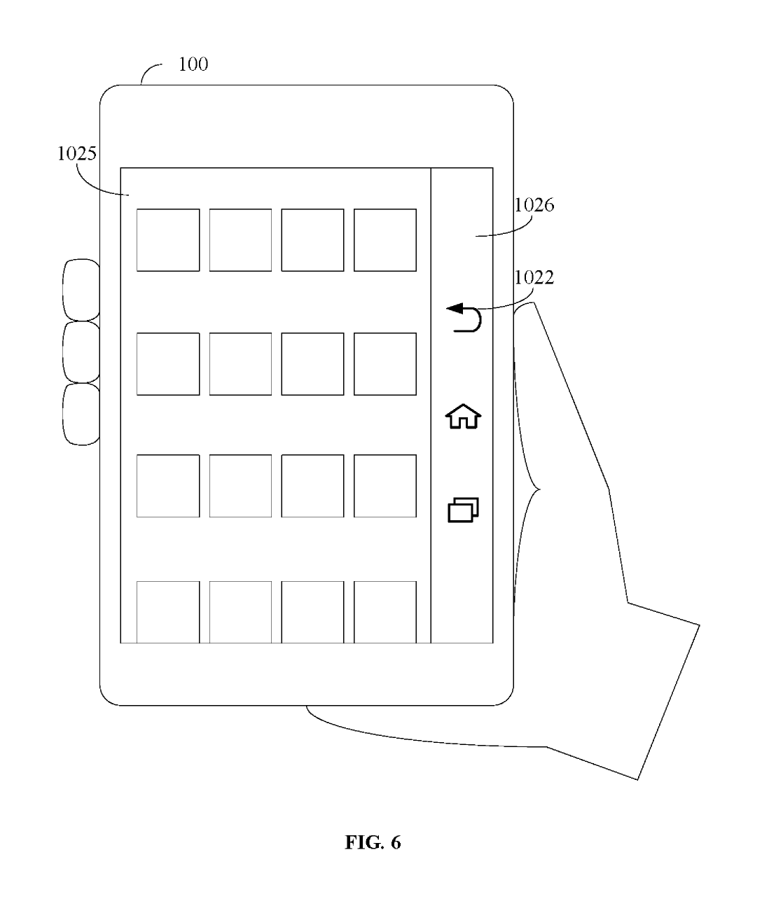

The display device 102 continues to display the first interface 1020 shown in FIG. 2 as long as the electronic device 100 is held by two hands. The display device 102 displays a second interface 1023 shown in FIG. 5 if the electronic device 100 is held by the left hand. The second interface 1023 includes a second sidebar 1024 in which the virtual buttons 1022 are displayed. In at least one embodiment, the second sidebar 1024 is displayed on the left side of the second interface 1023. The display device 102 displays a third interface 1025 shown in FIG. 6 if the electronic device 100 is held by the right hand. The third interface 1025 includes a third sidebar 1026 in which the virtual buttons 1022 are displayed. In at least one embodiment, the third sidebar 1026 is displayed on the right side of the third interface 1025.

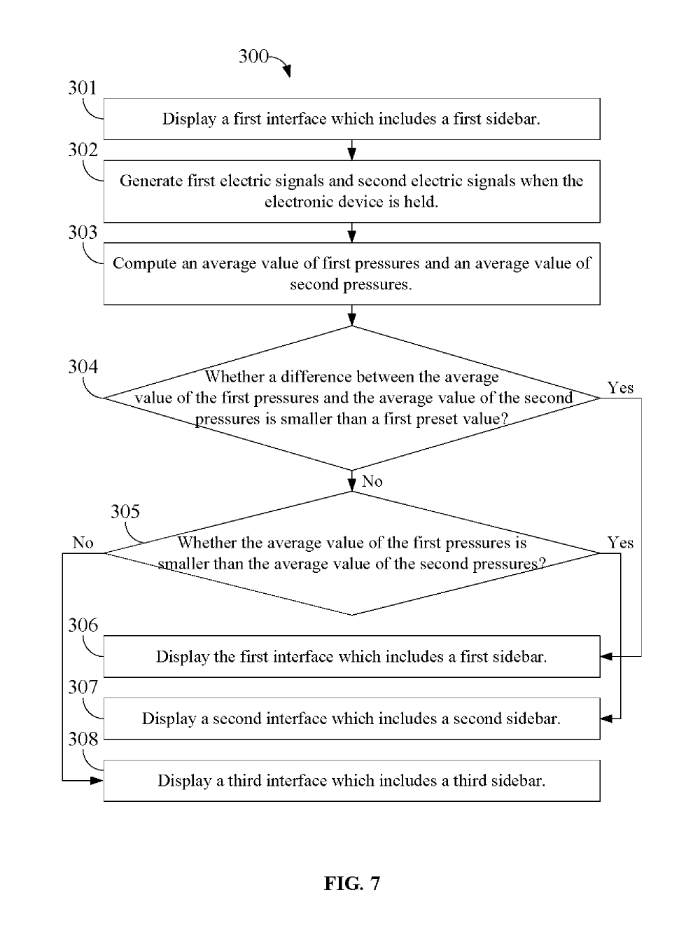

Referring to FIG. 7, a flowchart is presented in accordance with a first embodiment. A method 300 is provided by way of example, as there are varieties of ways to carry out the method. The method 300 described below can be carried out using the configurations illustrated in FIG. 1 and various elements of these figures are referenced in explaining example method 300. Each block shown in FIG. 7 represents one or more processes, methods, or subroutines, carried out in the exemplary method 300.

Furthermore, the illustrated order of blocks is by example only and the order of the blocks can be changed. Additional blocks may be added or fewer blocks may be utilized, without departing from this disclosure. The exemplary method 300 can begin at block 301.

At block 301, a display device displays a first interface which includes a first sidebar in which a number of virtual buttons are displayed. In at least one embodiment, the first sidebar is displayed on the bottom of the first interface. A user can tap one or more of the virtual buttons to operate an electronic device.

At block 302, a first sensing plate generates a number of first electric signals and a second sensing plate generates a number of second electric signals when the electronic device is handheld by a user.

At block 303, a computing module computes values of a number of first pressures applied on a first region and a second region of the first sensing plate based on the number of first electric signals and then computes an average value of the first pressures. The computing module further computes values of a number of second pressures applied on a third region and a fourth region of the second sensing plate based on the number of second electric signals and then computes an average value of the second pressures.

At block 304, a determination module determines a difference between the two respective average values, then the determination module determines whether the difference is smaller than a first preset value set by the user. If the difference is smaller than the first preset value, the determination module determines that the electronic device is held by two hands and block 306 is implemented. If the difference is not smaller than the first preset value, block 305 is implemented.

At block 305, the determination then determines whether the average value of the first pressures is smaller than the average value of the second pressures. If the average value of the first pressures is smaller than the average value of the second pressures, the determination module determines that the electronic device is held by a left hand and block 307 is implemented. If the average value of the first pressures is not smaller than the average value of the second pressures, the determination module determines that the electronic device is held by a right hand and block 308 is implemented.

At block 306, the display device continues to display the first interface.

At block 307, the display device displays a second interface. The second interface includes a second sidebar in which the virtual buttons are displayed. In at least one embodiment, the second sidebar is displayed on the left side of the second interface.

At block 308, the display device displays a third interface. The third interface includes a third sidebar in which the virtual buttons are displayed. In at least one embodiment, the third sidebar is displayed on the right side of the third interface.

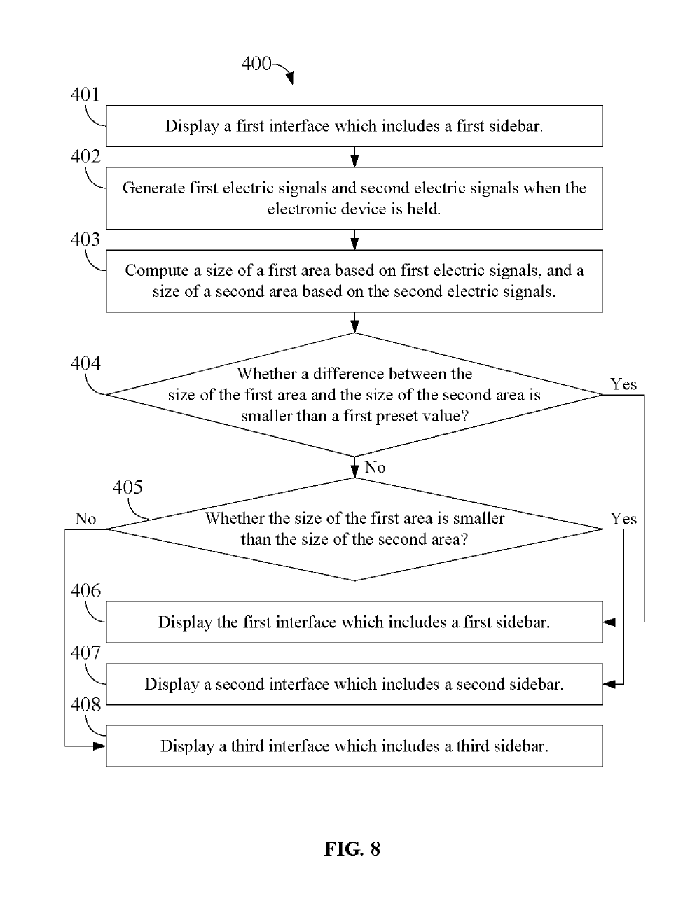

Referring to FIG. 8, a flowchart is presented in accordance with a second embodiment. A method 400 is provided by way of example, as there are varieties of ways to carry out the method. The method 400 described below can be carried out using the configurations illustrated in FIG. 1 and various elements of these figures are referenced in explaining example method 400. Each block shown in FIG. 8 represents one or more processes, methods, or subroutines, carried out in the exemplary method 400. Furthermore, the illustrated order of blocks is by example only and the order of the blocks can be changed. Additional blocks may be added or fewer blocks may be utilized, without departing from this disclosure. The exemplary method 400 can begin at block 401.

At block 401, a display device displays a first interface which includes a first sidebar in which a number of virtual buttons are displayed. In at least one embodiment, the first sidebar is displayed on the bottom of the first interface. A user can tap one or more of the virtual buttons to operate an electronic device.

At block 402, a first sensing plate generates a number of first electric signals and a second sensing plate generates a number of second electric signals when the electronic device is handheld by a user.

At block 403, a computing module computes a size of a first area of a first region and a second region based on the number of first electric signals. The computing module further computes a size of the second area of a third region and a fourth region based on the number of second electric signals.

At block 404, a determination module determines a difference between the respective sizes of the first area and of the second area, then the determination module determines whether the difference is smaller than a second preset value set by the user. If the difference is smaller than the second preset value, the determination module determines that the electronic device is held by two hands and block 406 is implemented. If the difference is not smaller than the second preset value, block 405 is implemented.

At block 405, the determination module determines whether the size of the first area is smaller than the size of the second area. If the size of the first area is smaller than the size of the second area, the determination module determines that the electronic device is held by the left hand and block 407 is implemented. If the size of the first area is not smaller than the size of the second area, the determination module determines that the electronic device is held by the right hand and block 408 is implemented.

At block 406, the display device continues to display the first interface.

At block 407, the display device displays a second interface. The second interface includes a second sidebar in which the virtual buttons are displayed. In at least one embodiment, the second sidebar is displayed on the left side of the second interface.

At block 408, the display device displays a third interface. The third interface includes a third sidebar in which the virtual buttons are displayed. In at least one embodiment, the third sidebar is displayed on the right side of the third interface.

The embodiments shown and described above are only examples. Many details are often found in the art such as the other features of an electronic device and method for controlling displayed interface according to manner in which device is handheld. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. An electronic device comprising:
at least one sensing plate mounted on the electronic device and configured to generate, when the electronic device is held, a plurality of electric signals;
at least one processor;
a non-transitory storage device coupled to the at least one processor and storing one or more programs, which when executed by the at least one processor, cause the at least one processor to:
compute holding data based on the plurality of electric signals;
determine a holding status according to the holding data; and
display an interface comprising a sidebar having, a location determined based on the holding status.

2. The electronic device of claim 1, wherein the sensing plate comprises a first sensing plate mounted on a first side on the electronic device, and a second sensing plate mounted on a second side, opposite to the first side, on the electronic device.

3. The electronic device of claim 2, wherein the first sensing plate and second sensing plate are both pressure sensitive sensing plate for sensing pressures applied thereon, and in “at least one sensing plate mounted on the electronic device and configured to generate a plurality of electric signals when the electronic device is held” and “compute holding data based on the plurality of electric signals”, the at least one processor is further to:
generate a plurality of first electric signals when the first sensing plate is touched;
generate a plurality of second electric signals when the second sensing plate is touched;
compute values of a plurality of first pressures applied on the first sensing plate based on the plurality of first electric signals and values of a plurality of second pressures applied on the second sensing plate based on the plurality of second electric signals; and
compute an average value of the first pressures and a average value of the second pressures.

4. The electronic device of claim 3, wherein in “determine a holding status according to the holding data”, the at least one processor is further to:
calculate a difference between the average value of the first pressures and the average value of the second pressures;
determine whether the difference is smaller than a first preset value;
determine that the electronic device is held by two hands if the difference is smaller than the first preset value;
determine whether the average value of the first pressures is smaller than the average value of the second pressures if the difference is greater than or equal to the first preset value;
determine that the electronic device is held by a left hand if the average value of the first pressure is smaller than the average value of the second pressure; and
determine that the electronic device is held by a right hand if the average value of the first pressures is greater than or equal to the average value of the second pressures.

5. The electronic device of claim 4, wherein in “display an interface comprising a sidebar corresponding to the holding status”, the at least one processor is further to:
display a first interface if the electronic device is determined been held by two hands, wherein the first sidebar is displayed on a first preset position on the first interface;
display a second interface which comprising a second sidebar if the electronic device is determined been held by the left hand, wherein the second sidebar is displayed on a second preset position, different from the first preset position, on the second interface; and
display a third interface which comprising a third sidebar if the electronic device is determined been held by the right hand, wherein the third sidebar is displayed on a third preset position, different from the first preset position and second preset position, on the third interface.

6. The electronic device of claim 2, wherein the first sensing plate and second sensing plate are both touch sensitive sensing plate for sensing touch area, and in “compute holding data based on the plurality of electric signals”, the at least one processor is further to: compute a size of a first area of a first region been touched on the first sensing plate and a size of a second area of a second region been touched on the second sensing plate.

7. The electronic device of claim 6, wherein in “determine a holding status according to the holding data”, the at least one processor is further to:
calculate a difference between the size of the first area and the size of the second area;
determine whether the difference is smaller than a second preset value;
determine that the electronic device is held by two hands if the difference is smaller than the second preset value;
determine whether the size of the first area is smaller than the size of the second area if the difference is greater than or equal to the second preset value;
determine that the electronic device is held by a left hand if the size of the first area is smaller than the size of the second area; and
determine that the electronic device is held by a right hand if the size of the first area is greater than or equal to the size of the second area.

8. The electronic device of claim 7, wherein in “display an interface comprising a sidebar corresponding to the holding status”, the at least one processor is further to:
display a first interface if the electronic device is determined been held by two hands, wherein the first sidebar is displayed on a fourth preset position on the first interface;
display a second interface which comprising a second sidebar if the electronic device is determined been held by the left hand, wherein the second sidebar is displayed on a fifth preset position, different from the fourth preset position, on the second interface; and
display a third interface which comprising a third sidebar if the electronic device is determined been held by the right hand, wherein the third sidebar is displayed on a sixth preset position, different from the fourth preset position and fifth preset position, of the third interface.

9. A computer-based method for controlling display for an electronic device being executed by at least one processor of the electronic device, the method comprising:
computing holding data based on a plurality of electric signals, wherein the plurality of electric signals are generated by at least one sensing plate mounted on the electronic device when the electronic device is held;
determining a holding status according to the holding data; and
displaying an interface comprising a sidebar, a location of the sidebar being determined corresponding to the holding status.

10. The method of claim 9, wherein the sensing plate comprises a first sensing plate mounted on a first side on the electronic device, and a second sensing plate mounted on a second side, opposite to the first side, on the electronic device.

11. The method of claim 10, wherein the first sensing plate and second sensing plate are both pressure sensitive sensing plate for sensing pressure applied thereon, and in “computing holding data based on a plurality of electric signals, wherein the plurality of electric signals are generated by at least one sensing plate mounted on the electronic device when the electronic device is held”, the method further comprising:
generating a plurality of first electric signals when the first sensing plate is touched;
generating a plurality of second electric signals when the second sensing plate is touched;
computing values of a plurality of first pressures applied on the first sensing plate based on the plurality of first electric signals and values of a plurality of second pressures applied on the second sensing plate based on the plurality of second electric signals; and
computing an average value of a first pressures and a average value of a second pressures.

12. The method of claim 11, wherein in “determining a holding status according to the holding data”, the method further comprising:
calculating a difference between the average value of the first pressures and the average value of the second pressures;
determining whether the difference is smaller than a first preset value;
determining that the electronic device is held by two hands if the difference is smaller than the first preset value;
determining whether the average value of the first pressures is smaller than the average value of the second pressures if the difference is greater than or equal to the first preset value;
determining that the electronic device is held by a left hand if the average value of the first pressures is smaller than the average value of the second pressures; and
determining that the electronic device is held by a right hand if the average value of the first pressures is greater than or equal to the average value of the second pressures.

13. The method of claim 12, wherein in “displaying an interface comprising a sidebar corresponding to the holding status”, the method further comprising:
displaying a first interface if the electronic device is determined been held by two hands, wherein the first sidebar is displayed on a first preset position on the first interface;
displaying a second interface which comprising a second sidebar if the electronic device is determined been held by the left hand, wherein the second sidebar is displayed on a second preset position, different from the first preset position, on the second interface; and
displaying a third interface which comprising a third sidebar if the electronic device is determined been held by the right hand, wherein the third sidebar is displayed on a third preset position, different from the first preset position and second preset position, on the third interface.

14. The method of claim 10, wherein the first sensing plate and second sensing plate are both touch sensitive sensing plate for sensing touch area, and in “computing holding data based on a plurality of electric signals, wherein the plurality of electric signals are generated by at least one sensing plate mounted on the electronic device when the electronic device is held”, the method further comprising: computing a size of a first area of a first region been touched on the first sensing plate and a size of a second area of a second region been touched on the second sensing plate.

15. The method of claim 14, wherein in “determining a holding status according to the holding data”, the at least one processor is further to:
calculating a difference between the size of the first area and the size of the second area;
determining whether the difference is smaller than a second preset value;
determining that the electronic device is held by two hands if the difference is smaller than the second preset value;
determining whether the size of the first area is smaller than the size of the second area if the difference is greater than or equal to the second preset value;
determining that the electronic device is held by a left hand if the size of the first area is smaller than the size of the second area; and
determining that the electronic device is held by a right hand if the size of the first area is greater than or equal to the size of the second area.

16. The method of claim 15, wherein in “displaying an interface comprising a sidebar corresponding to the holding status”, the method further comprising:
displaying a first interface if the electronic device is determined been held by two hands, wherein the first sidebar is displayed on a fourth preset position on the first interface;
displaying a second interface which comprising a second sidebar if the electronic device is determined been held by the left hand, wherein the second sidebar is displayed on a fifth preset position, different from the fourth preset position, on the second interface; and
displaying a third interface which comprising a third sidebar if the electronic device is determined been held by the right hand, wherein the third sidebar is displayed on a sixth preset position, different from the fourth preset position and fifth preset position, of the third interface.
